(19) United States
(12) Patent Application Publication
(10) Pub. No.: US 2004/0126662 A1
(43) Pub. Date: Jul. 1, 2004

(54) Non-aqueous electrolyte solution secondary battery and its negative electrode material

(76) Inventors: Kazushige Kohno, Hitachi (JP); Juichi Arai, Higashiibaraki (JP); Yoshiaki Arai, Kamakura (JP); Sadatoshi Ueda, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/635,608

(22) Filed: Aug. 7, 2003

(30) Foreign Application Priority Data
Dec. 26, 2002 (JP) 2002-376567

(51) Int. Cl. H01M 4/58; B60L 11/18

(52) U.S. Cl. 429/231.4; 180/65.3

(57) ABSTRACT

Disclosure is a non-aqueous electrolyte solution secondary battery having an improved negative electrode material. The negative electrode material contains a carbonaceous material that has a Lc value of 0.70 to 2.20 nm calculated from X-ray diffraction analysis, and a degree of graphitization R value (I_{D}/I_{G}) is 0.90 to 1.20, the degree of graphitization being obtained by the ratio of the peak height (I_{D}) representing a vibration mode based on a non-crystalline disorder structure within the range of from 1300 to 1400 cm⁻¹ that is measured by Raman spectrum to the peak height (I_{G}) representing a vibration mode based on a graphite crystalline structure within the range of 1580 to 1620 cm⁻¹.

### DESCRIPTION OF THE INVENTION

1. Field of the Invention

The present invention relates to a non-aqueous electrolyte solution secondary battery suitable for portable electronic devices, a negative electrode material, an electric car and a hybrid car.

2. Description of Prior Art

Graphite material has been used as a negative electrode material of a non-aqueous electrolyte solution secondary battery. For example, natural graphite materials, synthetic graphite materials made from coke, etc. have been used.) However, the natural graphite having a high crystalline degree or the synthetic graphite having been graphitized from cokes become flake graphite particles whose bonding between layers in the c-axis direction is easily broken, and an aspect ratio of the particles is large.

Since the flake graphite particles have a large aspect ratio, they tend to be arranged along the surface of a collector foil, when they are blended with a binder, followed by coating the mixture on the collector. As a result, warp of the graphite with respect to the c-axis is caused by repetition of absorption-desorption of lithium ions to graphite particles, which leads to break of the battery inside. Thus, the cycle characteristics of the battery decreases, and charge-discharge efficiency will be lowered as well.

In the graphite material, lithium ions are intercalated into and extracted from the layer structure on the rate of one lithium ion per 6 carbon atoms, and therefore, a theoretical capacity is 372 mAh/g.

On the other hand, there have been proposed carbonaceous materials that have a higher discharge capacity than the graphite material. The artificial carbonaceous materials are prepared by heat-treating to effect co-carbonization of petroleum pitch or coal pitch. According to this method, a negative electrode material that has a discharge capacity superior to the theoretical capacity of graphite material is provided.

In Japanese Patent Laid-open 08-115723 (1996), a carbonaceous material is proposed in which petroleum pitch or coal pitch is heat-treated or co-carbonized to produce a carbonaceous material having a higher discharge capacity.

The material disclosed in patent publication No. 1 exhibits the charge-discharge efficiency of at most 86.1% when employed in a battery, which is lower than that of graphite material.

### SUMMARY OF THE INVENTION

It is an object of the present invention to provide a non-aqueous electrolyte solution secondary battery having superior charge capacity and charge-discharge efficiency and a negative electrode material. The secondary batteries of the present invention are particularly useful for electric cars, hybrid cars and electric appliances.

The present invention employs a carbonaceous material has a degree of graphitization R value (I_{D}/I_{G}) is 0.90 to 1.20, the degree of graphitization being obtained by the ratio of the peak height (I_{D}) representing a vibration mode based on a non-crystalline disorder structure within the range of 1300 to 1400 cm⁻¹ that is measured by Roman spectrum to the peak height (I_{G}) representing a vibration mode based on a graphite crystalline structure within the range of from 1580 to 1620 cm⁻¹. The carbonaceous material of the present invention has a Lc value or a length of c axis of the crystal 0.70 to 2.20 nm calculated from X-ray diffraction analysis, and According to the present invention, we propose a non-aqueous electrolyte solution secondary battery having a higher discharge capacity than the conventional one, and a carbonaceous more suitable material for the lithium secondary batteries.

### BRIEF DESCRIPTION OF DRAWINGS

FIG. 1 is a Raman spectrum of the negative electrode material of the present invention.

FIG. 2 is a graph showing relationship between charge-discharge efficiency and a R value.

FIG. 3 is a graph showing relationship between discharge capacity and a R value.

FIG. 4 is a graph showing relationship between charge-discharge efficiency and Lc value.

FIG. 5 is a graph showing relationship between discharge capacity and Lc.

FIG. 6 is a partially sectional view of a cylinder type lithium secondary battery to which the present invention is applied.

### DETAILED DESCRIPTION OF PREFERRED EMBODIMENTS

When the Lc value is less than 0.70 nm, the discharge capacity and the charge-discharge efficiency may be greatly lowered. When the Lc value is more than 2.20 nm, the discharge capacity may be lowered very much, even though the charge efficiency may be high. When the degree of graphitization (Id/IG) is 0.90 or less or 1.20 or more, the discharge capacity and the charge-discharge efficiency may be greatly lowered.

Accordingly, one aspect of the present invention provides a lithium non-aqueous electrolyte solution secondary battery characterized by comprising a positive electrode having a positive active material that is capable of absorbing and desorbing lithium ions, the active material being formed on both faces of a current collector sheet, a negative electrode having a negative active material that is capable of absorbing and desorbing the lithium ions, and a non-aqueous electrolyte containing a lithium salt, the positive electrode and the negative electrode being wound alternately or laminated alternately through a separator, wherein the negative electrode contains carbonaceous material, and a discharge capacity per 1 gram of carbonaceous material is 370 (mAh/g) or more and charge-discharge efficiency is 85.8% or more. Preferably, carbonaceous materials should have Lc values of 0.70 to 2.2 nm.

The present invention also provides a lithium secondary battery, wherein the negative electrode has the Lc value of 0.7 to 1.7 nm, preferably 0.75 to 1.5 nm, and has the degree of graphitization and by R value (I_{D}/I_{G}) of more than 1.00 but 1.20 or less.

The discharge capacity and charge-discharge efficiency were determined by using test cells. The test cells comprise metal Li as a counter-electrode, a negative electrode to be evaluated and a spacer. Each of these components was stacked to constitute the test cell. The values of the negative material in the claims are defined as this value. On the other hand, in lithium batteries, a counter-electrode was a positive active material. The negative material, the positive active material and a spacer are stacked or laminated in several layers to constitute a battery.

The lithium secondary battery of the present invention is further featured by the Lc value of 1.04 to 2.20 nm, preferably 1.10 to 2.15 nm, and the R value of 0.9 to les than 1.0.

The crystal size Lc that was used as a parameter for doping lithium ions into crystals was adjusted based on the conventional evaluation of the negative electrode material. On the other hand, in the present invention, the Lc value of the carbonaceous material is optimized. Further, the degree of graphitization R value on the surface of the carbonaceous material that is a site for reversibly doping/undoping lithium ions is adjusted such that the material has a crystalline nature of and a carbonaceous nature as well. According to this adjustment, the negative electrode material of the present invention has the discharge capacity and the charge-discharge efficiency much better than the conventional graphite negative electrode material.

Binder materials for tightly bonding the negative electrode material with the collector are a copolymer of polyvinylidene fluoride and propylene hexafluoride, copolymer of ethylene, propylene and diene, etc, for example. As a non-aqueous solvent, propylene carbonate, tetrahydrofuran, dimethylcarbonate-1,2-dimethoxyethane, etc or mixtures thereof are suitable solvents. As electrolytes, lithium perchlorate, lithium borofluoride, lithium bis-trifluoromethyl sulfoneimide, etc can be used. As positive electrode materials, there are LiCoO₂, LiNiO₂, LiMnxNi₁₋ₓO₂, LiMn₂O₄, LiMnO₂, etc, wherein x is not less than 0.001, but not larger than 0.5.

The present invention also provides an electric car that is driven by a motor using the secondary battery as a power source and a hybrid car driven by a motor using a secondary battery and an internal combustion engine, wherein the secondary battery is the non-aqueous secondary battery described above.

The present invention will be described by way of examples in detail. The binders, non-aqueous solvents, collectors, electrolytes, etc are just examples, but the invention does not intend to limit the scope of claims to these materials.

### EXAMPLE 1

A method of the negative electrode material for the non-aqueous electrolyte solution secondary battery is shown in the following. In sample Nos. 1 to 5, carbon source material was dried material of extracted coffee ground that was dried in a hot air oven. The extracted coffee ground were heated to 300° C. at an elevation rate of 5° C./minute and kept at 300° C. for 1 hour in air. Then, the dried ground were powdered and sieved to remove rough particles of 70 micrometers or more.

The sieved powder was heated to 700° C. at an elevation rate of 5° C./minute in vacuum of 10⁻² Torr, and kept for 1 hour. Then the temperature was elevated to 1000 to 1400° C. at an elevation rate of 5° C./minute, followed by keeping the temperature for 2 hours.

In comparative examples 1 to 3 and sample 6, the raw material was the same as that of samples 1 to 5, but the highest temperatures were 900° C. and 1200° C. for 10 hours, respectively. The sintering atmosphere was Ar atmosphere. Other sintering conditions were the same as those of samples 1 to 5.

In the following, there is shown a method of evaluating the negative electrode material characteristics, using the negative electrode prepared from the negative electrode material. 10 Parts by weight of polyvinylidene fluoride was added to the negative electrode material, and 1-methyl-2-pyrrolidone was added to the mixture as a solvent to make a mixture of a solid matter content of 45% by weight. The resulting slurry was coated on copper foil as a collector, and the coating was dried in a constant temperature oven at 120° C. for 3 hours. The foil with the coating was punched to make electrodes of 15 mm in diameter.

There is shown a method of evaluating the Lc value representing a thickness of a crystal of the carbonaceous material as the negative electrode material.

At first, the punched negative electrodes prepared by the method mentioned-above were dipped in 1-methyl-pyrrolidone to separate the collector and the negative electrode material. The separated or pilled off negative electrode material was put on a glass plate to dry it at 110° C. for 2 hours. After drying, the sample was set on a sample holder of an X-ray diffraction analyzer. The Lc value was obtained in such a manner that a diffraction angle θ and a half wave value β of d (002) were measured by a powder diffraction method and the Lc value was calculated by the equation 1.

Lc=K×(λ/β)×cos θ (equation 1)

In the equation, λ is a wavelength of X-ray.

A method of evaluating an R value (I_{D}/I_{G}) representing the degree of graphitization is shown in the following. At first, the punched negative electrodes having a diameter of 15 mm were dipped in 1-methyl-pyrrolidone to separate the collector and the negative electrode material. The separated negative electrode material was put on a glass plate, and the sample was dried at 110° C. for 2 hours. After drying, the sample was set in a Raman-spectrometer. The measurement of Raman spectrum was conducted by NRS-2100 made by Japan Spectrum, and an argon laser of a wavelength of 514.5 nm was used. The exposure time was 120 seconds, and the number of accumulation was 2. The degree of graphitization was calculated by the equation 2 shown below.

Degree of graphitization=I_{D}/I_{G} (equation 2)

I_{D} is a peak height representing a vibration mode derived from non-crystalline distortion structure within a range of from 1300 to 1400 cm⁻¹, and I_{G} is a peak height representing a vibration mode derived from crystalline structure of graphite within a range of from 1580 to 1620 cm⁻¹.

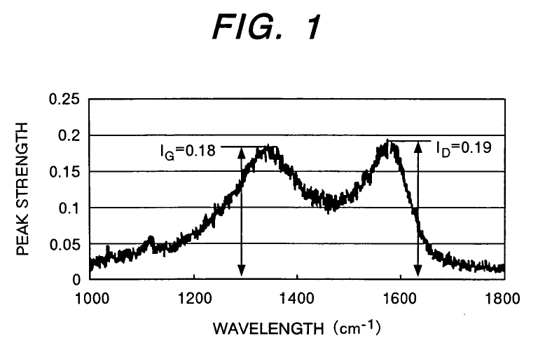

FIG. 1 is a chart of Raman spectrum of the negative electrode material of sample 3. As shown in FIG. 1, I_{D} measured by Raman spectrometry is 0.19 and IG is 0.18. The degree of graphitization calculated by the equation 2 using the above numbers is 0.948.

Test cells were prepared to evaluate the negative electrode material. The test cells used for the evaluation each comprises the punched negative electrode material of 15 mm diameter and a lithium foil a counter electrode of 1 mm thickness were opposed to each other by means of a separator made of polypropylene. A non-aqueous electrolyte solution was filled in the cell.

The electrolyte solution used in this example consists of a mixed solvent of ethylene carbonate and methyl ethyl carbonate (volume ratio 1:1) and as an electrolyte one mole of LiPF6. Charge-discharge conditions of the test cells were as follows.

(1) Charging; constant current charging at 4 mA (2.26 mA/cm²), constant charging at 0 V

(2) Discharging; current at 0.4 mA, voltage at 1.5 V

After charge-discharge, a discharge capacity per unit weight of the negative electrode material was calculated. The results were shown in Table 1 below. It was revealed that when the carbonaceous material having the Lc value of 0.70 to 2.20 and the degree of a graphitization R value (I_{D}/I_{G}) of 0.90 to 1.20 is used, the cell exhibits excellent characteristics such as a discharge capacity of 370 mAh/g or more and a discharge efficiency of 85.8% or more.

The degree of graphitization R value (I_{D}/I_{G}) is the ratio of the peak height (ID) representing vibration mode derived from non-crystalline distortion structure measured by Raman-spectrometry at 1300 to 1400 cm⁻¹ to the peak height (I_{G}) representing vibration mode derived from graphite crystalline structure measured at 1580 to 1620 cm⁻¹.

TABLE 1

| | | | Discharge | Charge- | |
|---|---|---|---|---|---|
| | Lc | R value | Capacity | Discharge | Sintering |
| Sample No. | (nm) | (I_{D}/I_{G}) | (mAh/g) | efficiency (%) | Condition |
| Sample 1 | 0.70 | 1.03 | 448 | 87.0 | 1100° C. |
| Sample 2 | 1.09 | 0.999 | 432 | 90.0 | 1150° C. |
| Sample 3 | 1.14 | 0.948 | 438 | 91.0 | 1220° C. |
| Sample 4 | 1.85 | 0.925 | 443 | 90.0 | 1300° C. |
| Sample 5 | 2.20 | 0.92 | 400 | 87.8 | 1400° C. |
| Sample 6 | 1.04 | 0.92 | 370 | 86.2 | 1200° C., Ar |
| | | | | | atmosphere |
| Comparative | 0.68 | 1.04 | 375 | 84.2 | 900° C. |
| 1 | | | | | |
| Comparative | 2.25 | 0.90 | 349 | 85.6 | 1200° C., |
| 1 | | | | | kept for |
| | | | | | 10 hrs. |
| Comparative | 0.69 | 1.14 | 370 | 85.5 | 900° C., |
| 1 | | | | | atmosphere |

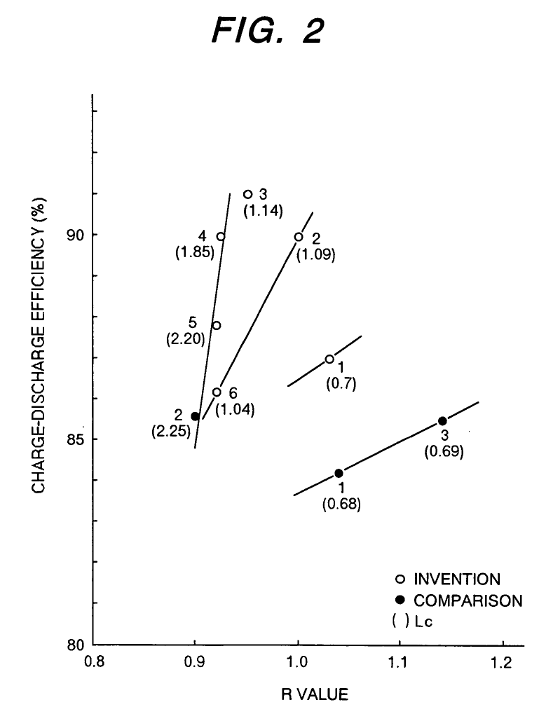

FIG. 2 is a graph showing relationship between discharge efficiency and the R value. As shown in FIG. 2, the charge-discharge efficiency will be remarkably improved by increasing the R value. However, if the Lc value is less than 0.7 nm as shown in the comparative samples, remarkable improvement of charge-discharge efficiency is not expected even if the R value is large. In the present invention, it is apparent that when Lc is 0.7 nm or more, the larger the Lc value, the higher the charge-discharge efficiency will be attained.

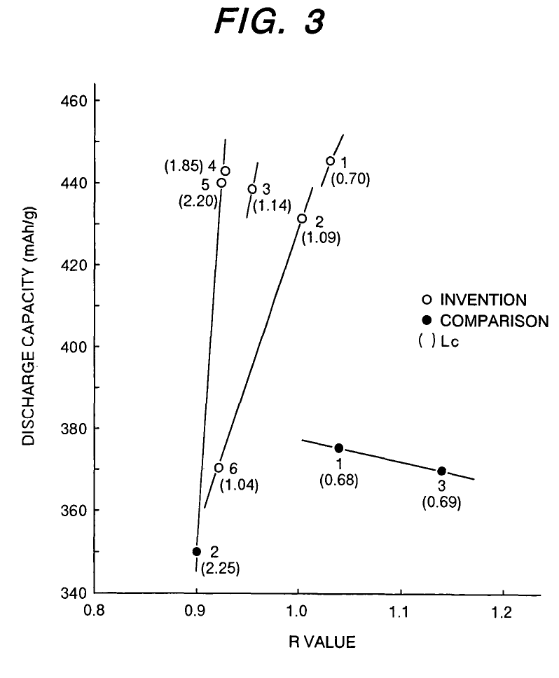

FIG. 3 is a graph showing relationship between discharge capacity and the R value. As shown in FIG. 3, it is apparent that the discharge capacity can be remarkably improved by increasing R value in the present invention. However, when Lc is less than 0.7 nm, the discharge capacity cannot be improved even if the R value is high.

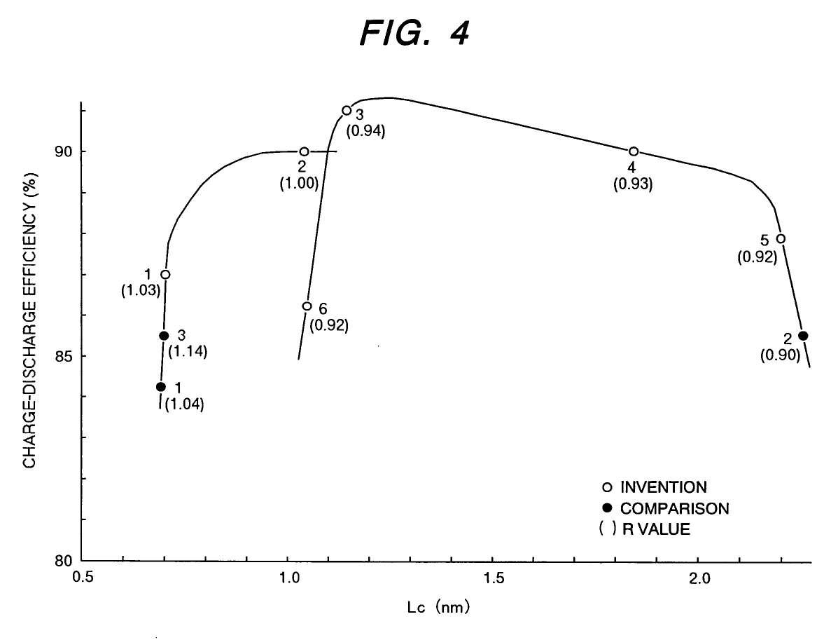

FIG. 4 is a graph showing relationship between charge-discharge efficiency and Lc value. As shown in FIG. 4, when R value is 0.9 to less than 1.00, high charge-discharge efficiency of 86% or more at Lc of 1.04 to 2.25 nm and of 87.5% or more at Lc of 1.10 to 2.15 nm could be obtained. When the R value exceeds 1.00, but 1.20 or less, charge-discharge efficiency was 85.8% or more at Lc of 0.70 to 1.7 nm, and 87.5% or more at Lc of 0.75 to 1.5 nm.

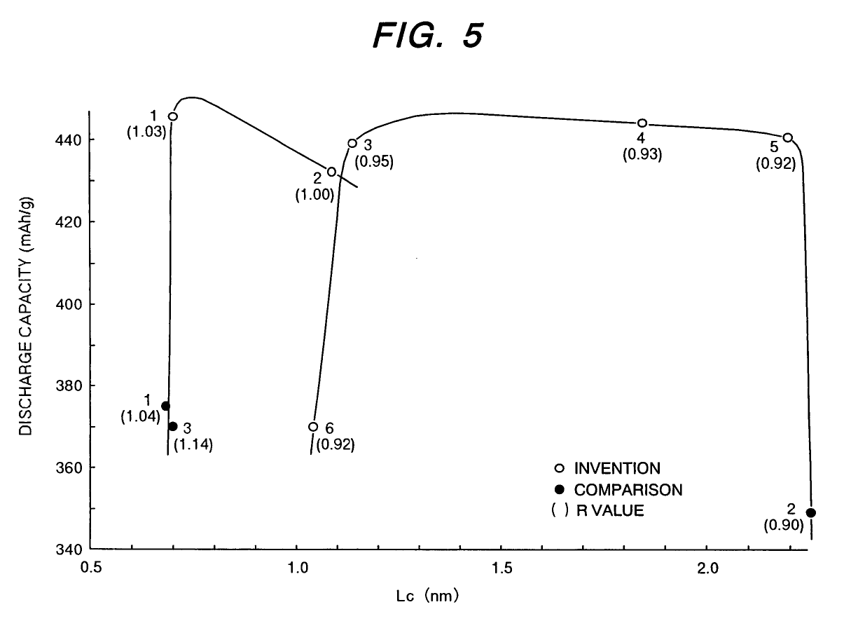

FIG. 5 is a graph showing relationship between discharge capacity and Lc. As shown in FIG. 5, when R value is 0.90 to less than 1.00, a high discharge capacity of 370 mAh/g or more was obtained at Lc of 1.04 to 2.20 nm, or 400 mAh/g or more at Lc of 1.10 to 2.15 nm. When R exceeds 1.20, but less than 1.20, a high discharge capacity of 370 mAh/g or more was obtained at Lc of 0.70 to 1.7 nm, or 400 mAh/g or more at Lc of 0.75 to 1.5 nm.

### EXAMPLE 2

There is shown a method of evaluation of performance of the lithium secondary battery using the negative electrode material for the non-aqueous electrolyte solution secondary battery.

In the following, there are shown methods of preparation of the electrodes and cells. LiMn₂O₄ was used as a positive electrode material. 87 Parts by weight of the positive electrode material, 8.7 parts by weight of synthetic graphite as a conductive aid and a solution of polyvynilidene fluoride dissolved in 1-methyl-2-pyrrolidone containing 4.3 parts by weight of a solid matter were mixed to obtain a paste containing. The paste was coated on both faces of a collector made of aluminum foil, and was dried at 80° C. for 3 hours. Then, the coating was pressed to produce a coating having a density of about 2.7 g/cm³, and dried at 120° C. for 2 hours in vacuum to obtain a positive electrode.

10 Parts by weight of polyvynilidene fluoride was added to each of the sample materials 7 to 12, and then 1-methyl-2-pyrrolidone was added to the mixture to obtain slurry having a solid matter concentration of 45% by weight. The resulting slurry was coated on both faces of a collector made of copper foil, and then the coating was dried at 80° C. for 3 hours. Thereafter, the coating was pressed to a coating having a density of about 1.0 g/cm³, and dried at 120° C. for 3 hours in vacuum. Lc values and degrees of graphitization of the resulting negative electrode material were evaluated in accordance with the methods mentioned earlier.

Sample cells 7 to 12 used the negative electrode materials of samples 1 to 6, and comparative samples 4 to 6 used the negative electrode materials of comparative samples 1 to 3. Thus, negative electrodes were prepared by the same manner mentioned earlier.

The resulting negative electrodes and positive electrodes were wound while inserting separator made of porous polyethylene film (thickness; 0.025 mm) between the electrodes. The wound electrodes were disposed in a cell can having an outer diameter of 18 mm and a length of 65 mm.

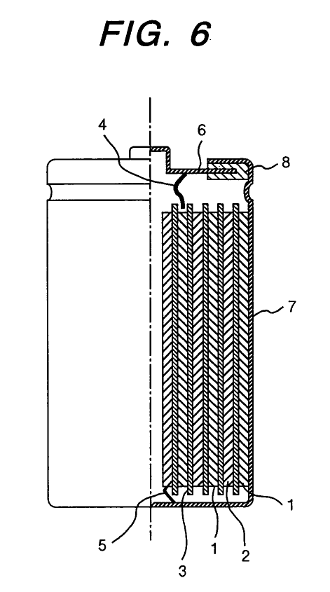

An electrolyte solution was prepared by dissolving 1 mole of LiF₆ as an electrolyte in a mixed solvent of ethylene carbonate and methyl ethyl carbonate (volume ratio=1:1). In Fig, there is shown a partially sectional front view of a cell used for tests. The lithium secondary battery shown in FIG. 6 was prepared as follows.

The sheet positive electrode 1 and sheet negative electrode 2 were laminated with separator 3 made of porous polyethylene film, and wound. The wound laminate was inserted into a battery can 7, and the can was sealed air-tightly. A positive electrode cap 6 is bonded to the positive electrode through a positive electrode tab 4, and the negative electrode 2 is bonded to the bottom of the can through a negative electrode tab 5. The positive electrode cap 6 is fixed to the can 7 by a gasket 8.

Discharge conditions of the batteries prepared in the above-mentioned manner are as follows.

Current; constant at 500 mA

Charge stop voltage; at 4.2 V

Discharge stop voltage; 2.8 V

Table 2 shows the results of evaluation of charge-discharge efficiency tests.

According to this example, when Lc is 0.70 to 2.20 nm and R value is 0.90 to less than 1.00, or R exceeds 1.00 and 1.20 or less, the discharge capacity was 86% or more.

TABLE 2

| | Lc | R value | Dicharge | Charge-discharge |
|---|---|---|---|---|
| | value | (I_{D}/I_{G}) | Capacity (Ah) | Efficiency (%) |
| Sample 7 | 0.70 | 0.948 | 1.22 | 87.0 |
| Sample 8 | 1.09 | 0.925 | 1.25 | 90.5 |
| Sample 9 | 1.14 | 0.920 | 1.15 | 91.0 |
| Sample 10 | 1.85 | 0.911 | 1.10 | 90.1 |
| Sample 11 | 2.20 | 1.040 | 1.06 | 87.3 |
| Sample 12 | 1.04 | 0.920 | 1.01 | 85.8 |
| Comparative 4 | 0.68 | 1.040 | 1.00 | 84.5 |
| Comparative 5 | 2.25 | 0.900 | 0.90 | 86.1 |
| Comparative 6 | 0.69 | 1.140 | 1.02 | 85.5 |

According to the present invention, it is possible to provide non-aqueous electrolyte solution secondary batteries with superior characteristics of discharge capacity and charge-discharge efficiency. Thus, the batteries are suitable for power sources of electronic appliances, electric cars, hybrid cars, etc.

What is claimed is:

1. A lithium non-aqueous electrolyte solution secondary battery characterized by comprising a positive electrode having a positive active material that is capable of absorbing and desorbing lithium ions, the active material being formed on both faces of a current collector sheet, a negative electrode having a negative active material that is capable of absorbing and desorbing the lithium ions, and a non-aqueous electrolyte containing a lithium salt, the positive electrode and the negative electrode being wound alternately or laminated alternately through a separator, wherein the negative electrode contains carbonaceous material, and a discharge capacity per 1 gram of carbonaceous material is 370 (mAh/g) or more and charge/discharge efficiency is 85.8% or more.

2. A lithium non-aqueous electrolyte solution secondary battery characterized by comprising a positive electrode having a positive active material that is capable of absorbing and desorbing lithium ions, the active material being formed on both faces of a current collector sheet, a negative electrode having a negative active material that is capable of absorbing and desorbing the lithium ions, and a non-aqueous electrolyte containing a lithium salt, the positive electrode and the negative electrode being wound alternately or laminated alternately through a separator, wherein the negative active material contains a carbonaceous material that has a Lc value of 0.70 to 2.20 nm calculated from X-ray diffraction analysis, and a degree of graphitization R value (I_{D}/I_{G}) is 0.90 to 1.20, the degree of graphitization being obtained by the ratio of the peak height (I_{D}) representing a vibration mode based on a non-crystalline disorder structure within the range of 1300 to 1400 cm⁻¹ that is measured by Raman spectrum to the peak height (I_{G}) representing a vibration mode based on a graphite crystalline structure within the range of from 1580 to 1620 cm^{-1.}

3. The no-aqueous electrolyte solution secondary battery as defined in claim 2, wherein the Lc value is 0.7 to 1.7 nm, and the degree of graphitization (I_{D}/I_{G}) is more than 1.00, but less than 1.20.

4. The no-aqueous electrolyte solution secondary battery as defined in claim 2, wherein the Lc value is 0.7 to 2.20 nm, and the degree of graphitization (I_{D}/I_{G}) is 0.9 to less than 1.0 nm.

5. A negative electrode material for a non-aqueous electrolyte solution secondary battery, which contains a carbonaceous material that has a Lc value of 0.70 to 2.20 nm calculated from X-ray diffraction analysis, and a degree of graphitization R value (I_{D}/I_{G}) is 0.90 to 1.20, the degree of graphitization being obtained by the ratio of the peak height (I_{D}) representing a vibration mode based on a non-crystalline disorder structure within the range of 1300 to 1400 cm⁻¹ that is measured by Raman spectrum to the peak height (I_{G}) representing a vibration mode based on a graphite crystalline structure within the range of 1580 to 1620 cm⁻¹.

6. The negative electrode material for a non-aqueous electrolyte solution secondary battery as defined in claim 5, wherein the carbonaceous material has Lc value is 0.7 to 1.7 nm, and the degree of graphitization (I_{D}/I_{G}) is more than 1.00, but less than 1.20.

7. The negative electrode material for a non-aqueous electrolyte solution secondary battery as defined in 5, wherein the Lc value is 0.7 to 2.20 nm, and the degree of graphitization (I_{D}/I_{G}) is 0.9 to less than 1.0 nm.

8. An electric car driven by a motor that is run by a secondary battery as a power source, wherein the secondary battery is the non-aqueous electrolyte solution secondary battery as defined in claim 1.

9. A hybrid car driven by an internal combustion engine and a motor that is run by a secondary battery, wherein the secondary battery is the non-aqueous electrolyte solution secondary battery as defined in claim 1.
